(19) United States
(12) Patent Application Publication
(10) Pub. No.: US 2015/0004841 A1
(43) Pub. Date: Jan. 1, 2015

(54) CONNECTOR WITH ELECTRONIC COMPONENT

(71) Applicant: Sumitomo Wiring Systems, Ltd., Yokkaichi-City (JP)

(72) Inventors: Michiyo Fujiwara, Yokkaichi-City (JP); Koichi Yokotani, Yokkaichi-City (JP)

(21) Appl. No.: 14/316,044

(22) Filed: Jun. 26, 2014

(30) Foreign Application Priority Data
Jun. 28, 2013 (JP) 2013-135980

(51) Int. Cl. H01R 13/66

(52) U.S. Cl. CPC H01R 13/6625
USPC 439/620.21

(57) ABSTRACT

A connector includes an electronic component (60) with an electronic component main body (61) extending in a front-back direction and a lead wire (62) projecting forward from a front end surface (61A) of the electronic component main body (61). A conductive member (40) is arranged before the electronic component (60) and is connected to the lead wire (62). The connector also has a housing (10, 20) into which the electronic component (60) and the conductive member (40) are mountable. A holding component (70) is separate from the housing (10, 20) and capable of filling up a clearance between the housing (10, 20) and the electronic component main body (61). The holding component (70) is deformable according to the size of a clearance between the electronic component main body (61) and the housing (10, 20).

### BACKGROUND

1. Field of the Invention

The invention relates to a connector with an electronic component.

2. Description of the Related Art

Japanese Unexamined Patent Publication No. 2007-287644 discloses a connector with a built-in electronic component such as a capacitor. The electronic component has a wide component main body and two lead wires are drawn out in opposite directions from opposite ends of this component main body. The lead wires are inserted respectively into through holes of busbars and soldered to the busbars. Thus, even if the connector with the electronic component is subjected to vibration, the component main body of the electronic component does not vibrate are large amount due to the support on the opposite sides and there is no possibility of breaking connecting parts with the busbars.

On the other hand, U.S. Patent Application Publication No. 2013/0040504 shows a connector with an electronic component that requires a longitudinal arrangement in which an electronic component main body is arranged in a front-back direction. In this case, lead wires are drawn out in the same direction from one end of the component main body in the electronic component. The lead wires are inserted through lead wire insertion holes on one axial end of a capacitor holding portion and are placed on terminal fittings. The lead wires and the terminal fittings then are resistance-welded.

Dimensional tolerances of the electronic component are large. If the component main body is formed to have slightly small dimensions, a space is formed between the capacitor holding portion and the electronic component main body in the configuration of U.S. Patent Application Publication No. 2013/0040504 and a stress is applied to the resistance-welded parts by vibration. Hence, there is a possibility of breakage.

The invention was completed based on the above situation and aims to reliably suppress the vibration of an electronic component in a connector with an electronic component.

### SUMMARY OF THE INVENTION

The invention is directed to a connector with an electronic component. The electronic component includes an electronic component main body extending in a front-back direction and a lead wire projecting forward from a front end surface of the electronic component main body. A conductive member is arranged before the electronic component and is to be connected to the lead wire. The connector further has a housing into which the electronic component and the conductive member are mountable. A holding component is separate from the housing and is mounted between the housing and the electronic component main body. The holding component is deformable according to the size of a clearance between the electronic component main body and the housing.

According to such a configuration, the electronic component main body is held by the holding component so that no clearance is formed between the electronic component main body and the housing. Further, since the holding component is deformable to absorb dimensional tolerances of the electronic component main body and fills up the clearance between the electronic component main body and the housing. Thus, vibration of the electronic component can be suppressed and the breakage of a connecting part of the lead wire and the conductive member can be avoided.

The housing may comprise a holder for holding the conductive member and a housing main body including an insertion opening through which the holder is insertable from the front. The housing main body is capable of accommodating the holder inside through the insertion opening. The holding component may be mounted on a rear end part of the electronic component main body while a front end part of the electronic component main body is held in the holder. The conductive member and the lead wire of the electronic component can be connected after the conductive member and the electronic component main body are held in the holder. Thus, operability is improved. Further, the holder holding the conductive member and the electronic component can be accommodated into the housing after the holding component is mounted on the electronic component main body. Hence, operability is improved even further.

The electronic component main body may have a substantially solid cylindrical shape. The holding component may have an inner peripheral surface formed into a substantially hollow cylindrical shape. An inner peripheral bottom surface of the holding component may have a substantially circular shape and a slit may be formed from the inner peripheral side surface toward a center of the inner peripheral bottom surface. The slit in the holding component is opened according to the size of the electronic component main body, thereby accommodating a size change caused by the dimensional tolerances of the electronic component main body.

The electronic component main body may have a substantially solid cylindrical shape. The holding component may be formed of a resilient member and include a cylinder portion having a substantially hollow cylindrical shape and configured to cover the electronic component main body and fill up a clearance to the housing. A projecting portion may project radially outward from the cylinder portion, and the housing may be formed with a recess capable of accommodating the projecting portion. The cylinder portion is a resilient component and can be deformed due to the dimensional tolerances of the electronic component main body and fill up the clearance between the housing and the electronic component main body to alleviate vibration. Further, the projecting portion improves mountability into the housing and prevents rotation of the holding component and the electronic component mounted with the holding component.

### BRIEF DESCRIPTION OF THE DRAWINGS

FIG. 1 is an exploded perspective view of a connector with an electronic component according to a first embodiment of the present invention.

FIG. 2 is a front view of a housing.

FIG. 3 is a plan view of the housing.

FIG. 4 is a section at a position iv-iv of FIG. 2.

FIG. 5 a front view of a holder.

FIG. 6 is a plan view of the holder.

FIG. 7 is a view showing a state before a capacitor is mounted into the holder shown in section at a position vii-vii of FIG. 4.

FIG. 8 is a perspective view showing a state where terminal fittings and the capacitor are mounted in the holder.

FIG. 9 is a front view showing the state where the terminal fittings and the capacitor are mounted in the holder.

FIG. 10 is a plan view showing a state before a retainer is mounted with the terminal fittings and the capacitor mounted in the holder.

FIG. 11 is a side view showing the state before the retainer is mounted with the terminal fittings and the capacitor mounted in the holder.

FIG. 12 is a front view of the retainer.

FIG. 13 is a bottom view of the retainer.

FIG. 14 is a section at a position xiv-xiv of FIG. 12.

FIG. 15 is a perspective view of the connector with the electronic component.

FIG. 16 is a front view of the connector with the electronic component.

FIG. 17 is a plan view partly in section at a position xvii-xvii of FIG. 16.

FIG. 18 is a section at a position xviii-xviii of FIG. 16.

FIG. 19 is a front view of a cap according to a second embodiment of the present invention.

FIG. 20 is a plan view of the cap.

FIG. 21 is a rear view of the cap.

FIG. 22 is a plan view partly in section of a connector with an electronic component of the second embodiment at the position xvii-xvii of FIG. 16.

### DETAILED DESCRIPTION OF THE PREFERRED EMBODIMENT

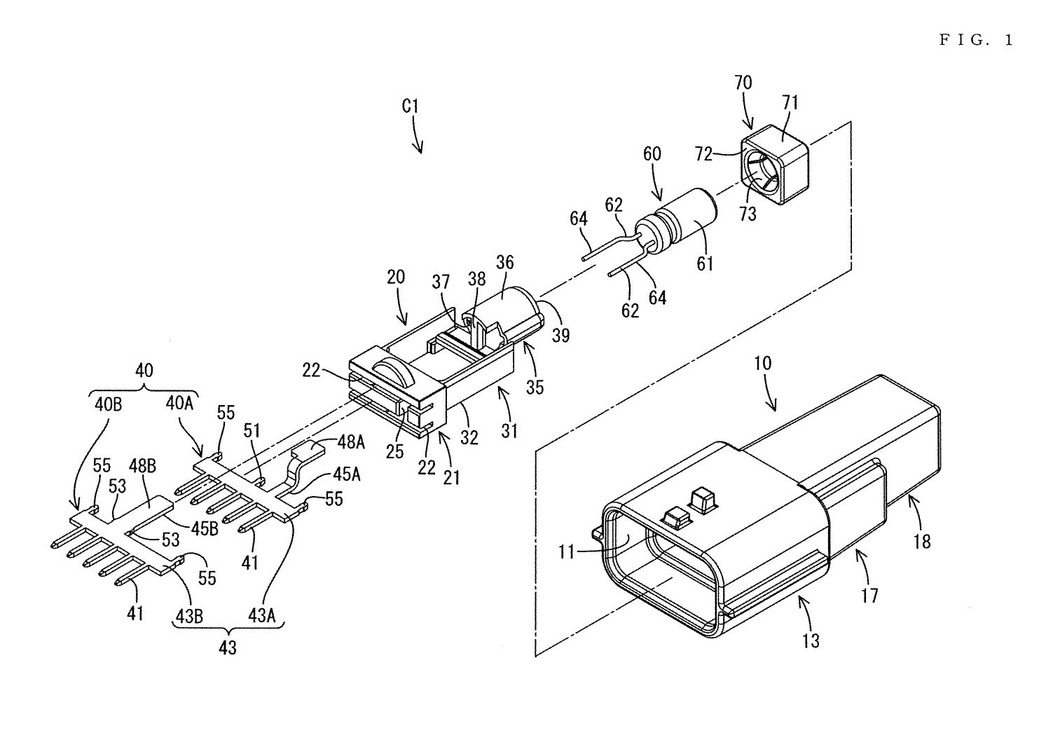

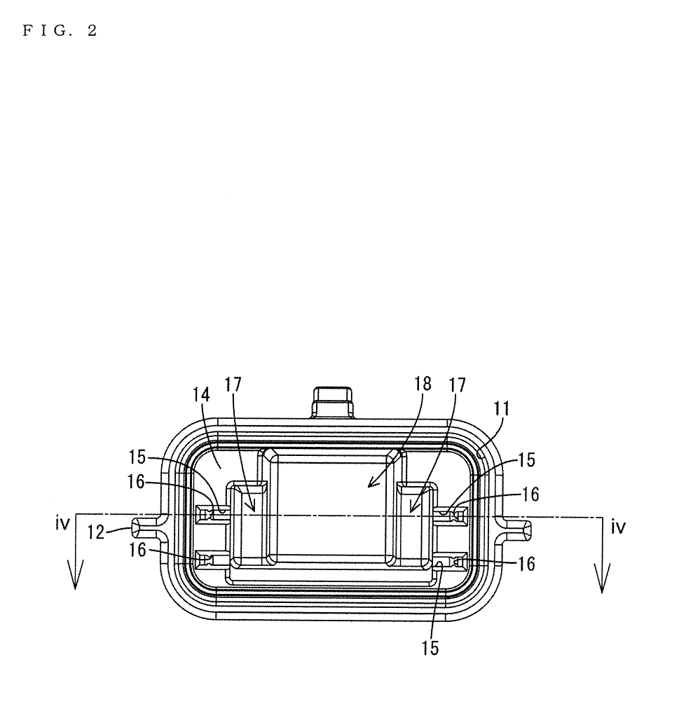

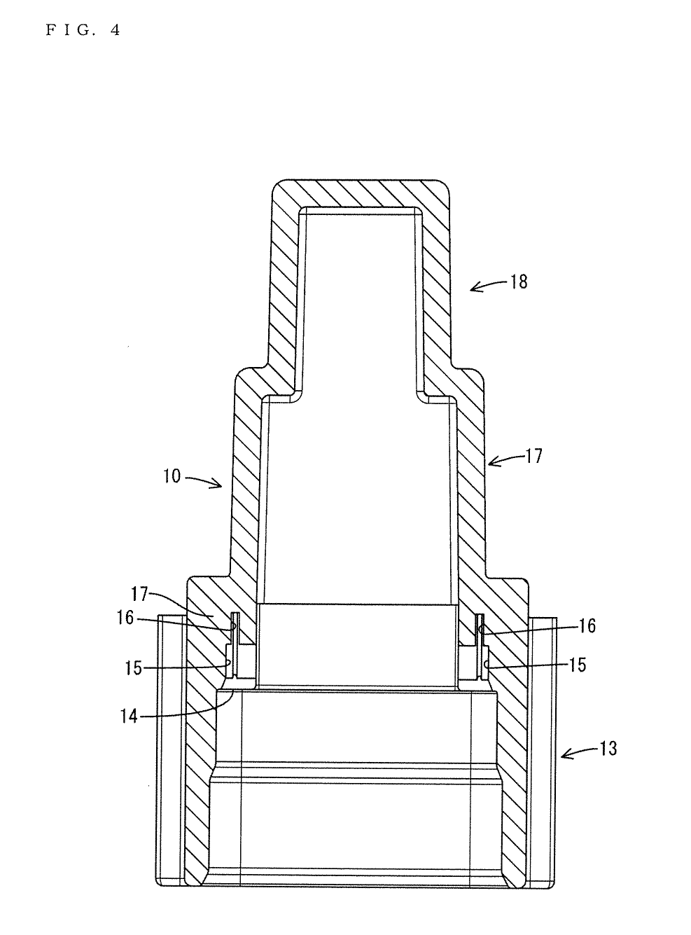

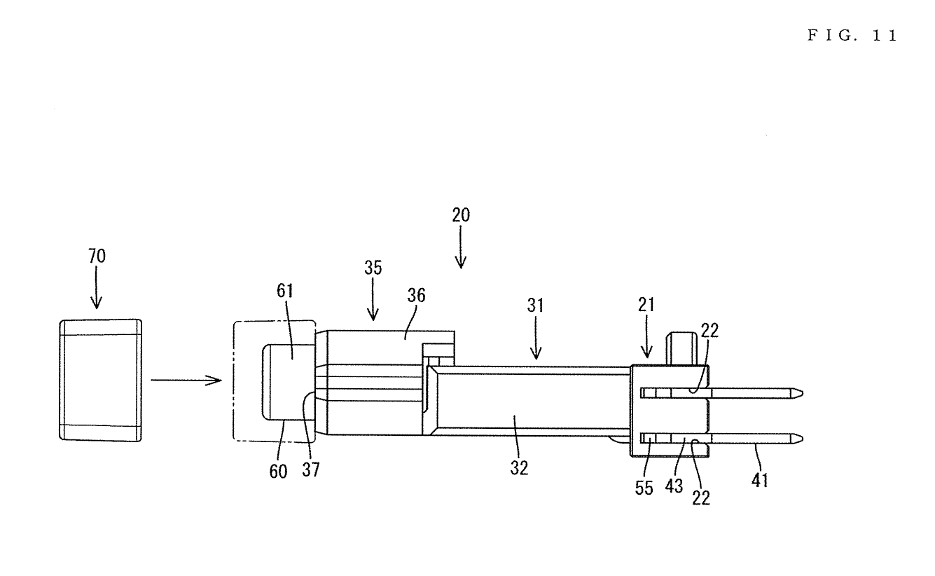

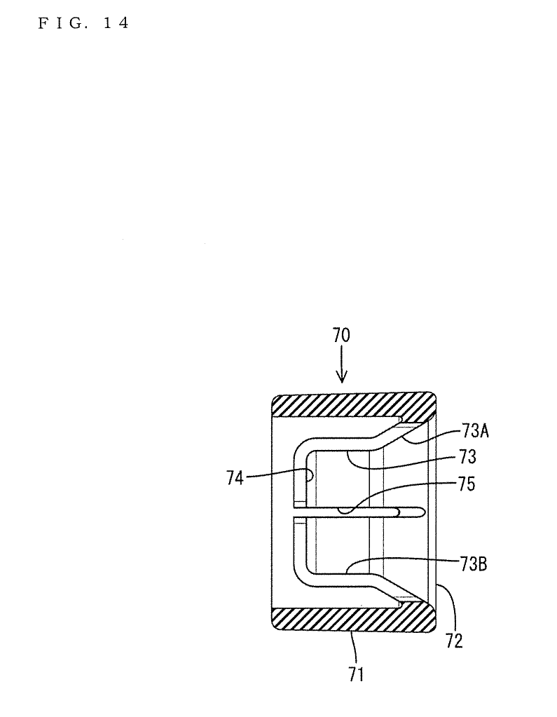

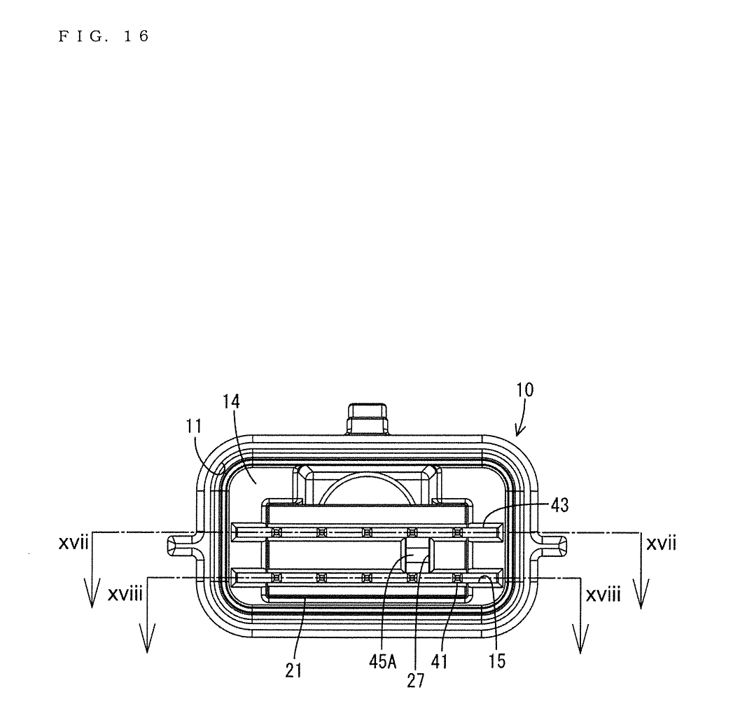

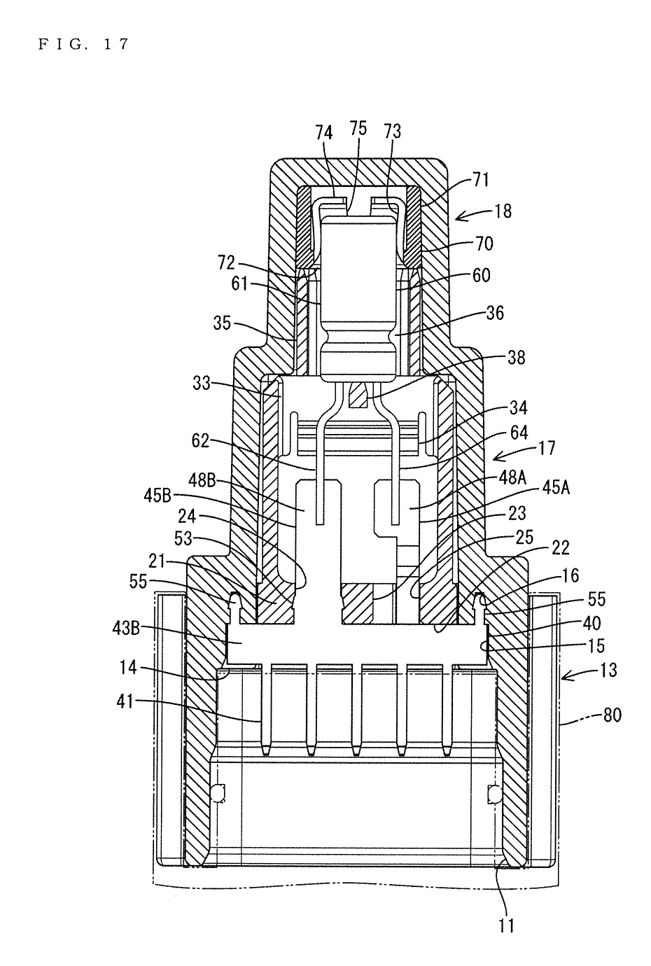

A connector in accordance with the invention is illustrated in FIGS. 1 to 18 and is identified by C1. The connector C1 has an electronic component therein for removing noise of electric/electronic devices and the like installed in an automotive vehicle. The connector C1 includes, as shown in FIG. 1, a bag-shaped housing main body 10 open only in one direction, a holder 20 to be accommodated in the housing main body 10, busbars 40 to be held in the holder 20, a capacitor 60 including a capacitor main body 61 and lead wires 62, and a retainer 70 for filling up a space between the capacitor main body 61 and the housing main body 10. Further, the connector C1 is a joint connector for collectively connecting a plurality of unillustrated wires drawn out from the electric/electronic devices installed in the automotive vehicle. The connector C1 includes two busbars 40 on a positive electrode side and a negative electrode side and the capacitor 60 is interposed between these positive and negative busbars 40. This connector C1 is connectable to a mating connector 80 (see FIG. 17). In the following description, a connection surface side of the connector C1 to be connected to the mating connector 80 is referred to as a front side and an opposite side is referred to as a rear side in each constituent member, and vertical and lateral directions are based on FIG. 2.

The housing main body 10 is made of synthetic resin and includes, as shown in FIG. 1, an insertion opening 11 into which the holder 20 is insertable from the front. The housing main body 10 has a receptacle 13 that forms the insertion opening 11 and that can receive the mating connector 80 (see FIG. 17). A holder accommodating portion 17 is rearward of receptacle 13 and accommodates an intermediate portion 31 of the holder 20. A capacitor accommodating portion 18 is rearward of the holder accommodating portion 17 and accommodates the capacitor 60. The receptacle 13, the holder accommodating portion 17 and the capacitor accommodating portion 18 are formed unitarily. Thus, the housing main body 10 is in the form of a bag including the insertion opening 11 and having a three-step structure.

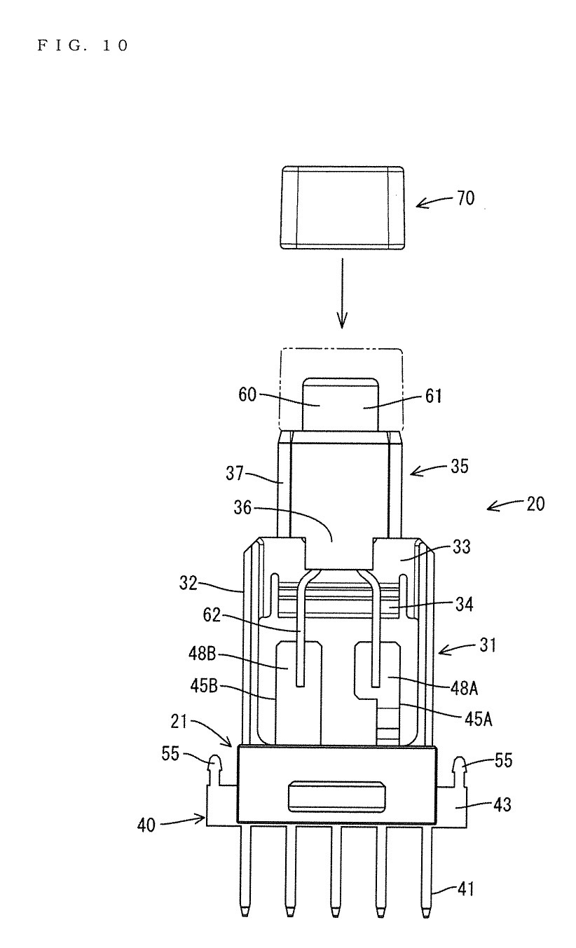

The busbar 40 is formed by punching an electrically conductive plate material such as metal and applying bending and the like to a punched-out piece as shown in FIG. 1. Each busbar 40 includes a plurality of terminals 41 to be connected to female terminal fittings held in the mating connector 80 and a strip-like coupling 43 that couples the terminals 41 in a comb-teeth manner. Positive and negative busbars 40 are arranged in upper and lower levels in a height direction of the holder 20, as shown in FIG. 9. The busbar 40 in the lower level is referred to as a first busbar 40A and the busbar 40 in the upper level is referred to as a second busbar 40B. As shown in FIG. 1, the first busbar 40A includes a first electronic component connecting portion 45A, and the second busbar 40B includes a second electronic component connecting portion 45B. The first and second electronic component connecting portions 45A, 45B are connected to the capacitor 60. In the following description, the first and second electronic component connecting portions 45A, 45B are referred to collectively as electronic component connecting portions 45A, 45B in describing a configuration common to the first and second electronic component connecting portions 45A, 45B.

The terminals 41 are in the form of tabs and five terminals 41 project side by side at constant intervals on the front end surface of each strip-like coupling 43. The electronic component connecting portion 45A, 45B is formed on a rear end surface of the strip-like coupling 43 opposite to the terminals 41 and extends substantially perpendicular to the strip-like coupling 43.

As shown in FIG. 10, a width of each strip-like coupling 43 exceeds a width of a busbar holding portion 21 of the holder 20. Thus, when the busbars 40 are mounted into the holder 20, each strip-like coupling 43 projects from opposite left and right ends of the busbar holding portion 21.

The first electronic component connecting portion 45A of the first busbar 40A and the second electronic component connecting portion 45B of the second busbar 40B are arranged at a fixed distance from each other in a width direction of the holder 20 as shown in FIG. 10 when mounted.

As shown in FIG. 17, the second electronic component connecting portion 45B projects back from a position of the second strip-like coupling 43B) displaced to the left from a center in the width direction of the holder 20, and that projecting part forms a second welding portion 48B to be welded to the lead wire 62 of the capacitor 60. Further, the second electronic component connecting portion 45B is flat without any step over the entire length including the second welding portion 48B. Since there is no step between the second electronic component connecting portion 45B and the second strip-like coupling 43B, the entire second busbar piece 40B is flat. Note that a width of the second electronic component connecting portion 45B is substantially constant over the entire length excluding second press-fit portions 53.

The second electronic component connecting portion 45B is formed with the second press-fit portions 53. Since the second press-fit portions 53 are formed to be wider toward a front side, larger parts bite into resin as the second press-fit portions 53 are press-fit into a second connecting portion insertion hole 24 to be described later. Specifically, a wedge-shaped press-fit portion is formed by combining a pair of second press-fit portions 53 provided on opposite left and right sides of the second electronic component connecting portion 45B. As shown in FIG. 17, the second press-fit portions 53 function to retain and hold the second busbar piece 40B arranged at a predetermined position in the holder 20 by being locked substantially in a lengthwise central part of the busbar piece holding portion 21 in a front-back direction.

As shown in FIG. 1, the first electronic component connecting portion 45A projects backward from a position displaced to the right from a lateral center of the corresponding strip-like coupling portion (referred to as a first strip-like coupling portion 43A), and that projecting part forms a first welding portion 48A to be welded to the lead wire 62 of the capacitor 60 to be described later. The first electronic component connecting portion 45A is bent at a right angle twice at intermediate positions in a length direction (front-back direction) so that the first welding portion 48A on the tip thereof is arranged substantially at the same height as the second electronic component connecting portion 45B. Specifically, the first electronic component connecting portion 45A is bent backward at the same height position as the second electronic component connecting portion 45B after being bent upward at an intermediate position in the length direction thereof. Further, the welding portion 48A of the first electronic component connecting portion 45A is shaped to be slightly wider than a bent part.

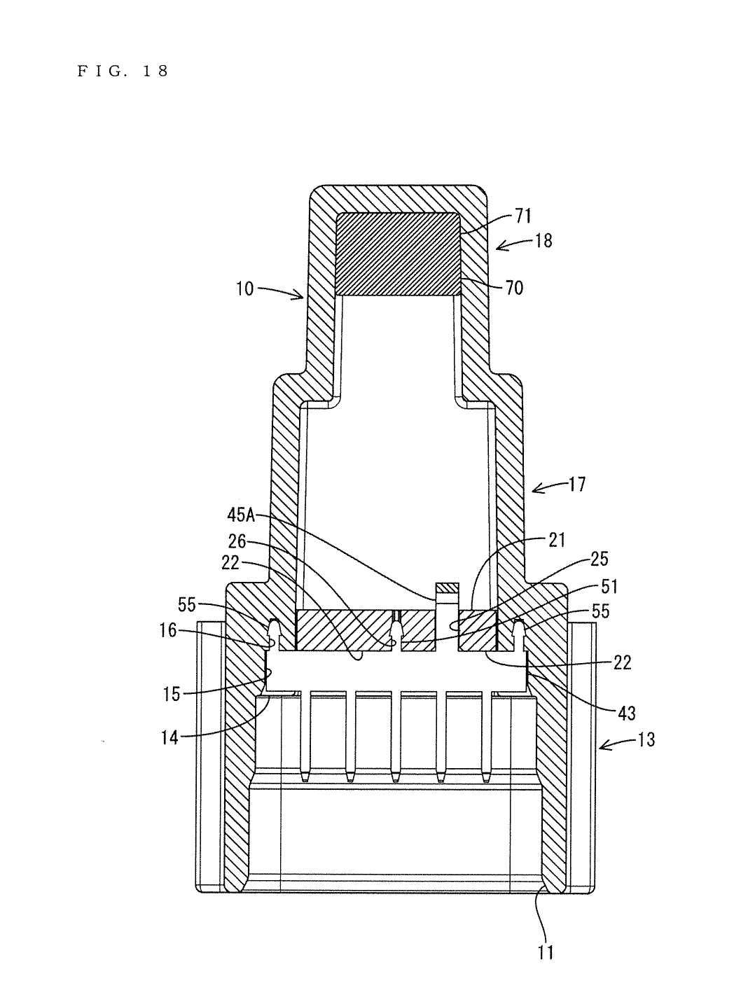

As shown in FIG. 18, the first busbar piece 40A includes a first press-fit portion 51 to be press-fit into a holder press-fit hole 26 formed in the holder 20 by being pushed backward relative to the busbar piece holding portion 21 of the holder 20 to be described later. The first press-fit portion 51 projects toward the same side as the first electronic component connecting portion 45A from the first strip-like coupling portion 43A, i.e. projects toward a side of the first strip-like coupling portion 43A opposite to the first terminal portions 41. A length of the first press-fit portion 51 is shorter than a length of the busbar piece holding portion 21 in the front-back direction. Further, a tip side of the first press-fit portion 51 is wedge-shaped.

Further, as shown in FIGS. 17 and 18, each busbar piece 40 includes housing press-fit portions 55 to be press-fit into housing press-fit holes 16 formed in the housing main body 10 to be described later by being pushed backward relative to the housing main body 10. The housing press-fit portions 55 project toward the same side as the electronic component connecting portion 45A, 45B from the strip-like coupling portion 43, i.e. project toward the side opposite to the terminal portions 41. Lengths of the housing press-fit portions 55 are substantially equal to that of the first press-fit portion 51, and tip sides thereof are wedge-shaped. Further, each busbar piece 40 includes a pair of the housing press-fit portions 55. The pair of housing press-fit portions 55 are located on opposite end parts of the strip-like coupling portion 43 in the lateral direction. The housing press-fit portions 55 are arranged to project to both left and right sides from the busbar piece holding portion 21 when the busbar piece 40 is mounted into the holder 20.

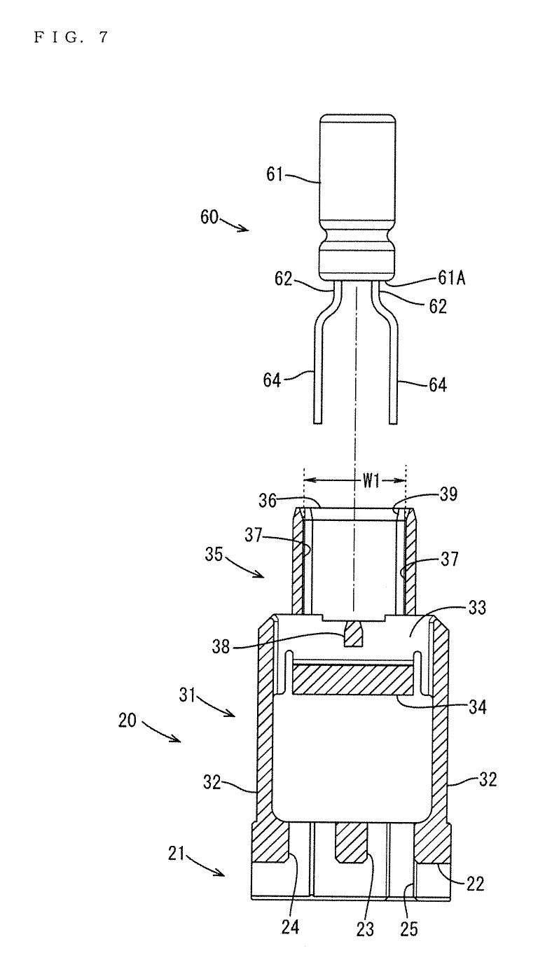

As shown in FIG. 7, the capacitor 60 is an aluminum electrolytic capacitor and includes the capacitor main body 61 formed into a substantially solid cylindrical shape and the pair of positive and negative lead wires 62 drawn out from a front end surface 61A of the capacitor main body 61. The lead wires 62 are in the form of round pins and project from the front end surface 61A of the capacitor main body 61 substantially in a perpendicular direction (axial direction of the capacitor main body 61), and end parts thereof are cranked toward sides radially outward of the outer peripheral surface of the capacitor main body 61 and then extend forward at sides outward of the outer peripheral surface of the capacitor main body 61, whereby extending parts form lead wire projecting portions 64. This pair of lead wires 62 are arranged above the welding portions 48A, 48B of the busbar pieces 40 when the capacitor 60 is mounted in the front-back direction of the connector Cl (longitudinal arrangement), and connected to the electronic component connecting portions 45 by resistance welding.

Next, the structure of the holder 20 is described.

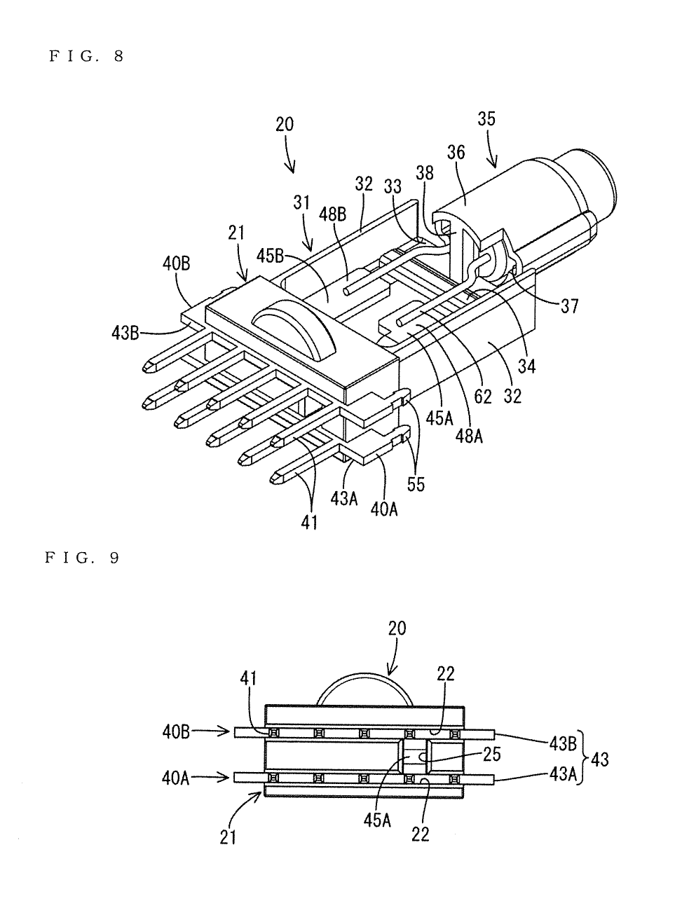

The holder 20 is made of synthetic resin and, as shown in FIG. 8, shaped to be long and narrow in the front-back direction as a whole and formed with the busbar piece holding portion 21 for holding the busbar pieces 40 on a front end side thereof and an capacitor holding portion 35 for holding the capacitor 60 on a rear end side thereof. The busbar pieces 40 and the capacitor 60 are connected in the intermediate portion 31 formed between the busbar piece holding portion 21 and the capacitor holding portion 35 of the holder 20. Note that the capacitor holding portion 35 is located substantially in a widthwise (lateral) center of the holder 20.

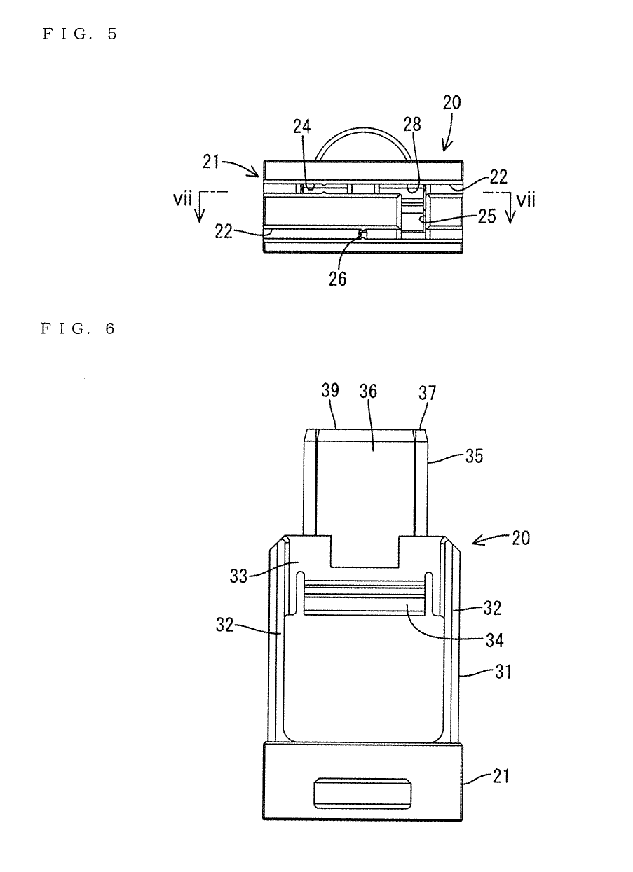

As shown in FIG. 6, the busbar piece holding portion 21 is in the form of a substantially rectangular block long in the width direction of the holder 20. As shown in FIG. 5, the busbar piece holding portion 21 is formed with mounting grooves 22 into which the strip-like coupling portions 43 of the busbar pieces 40 are to be mounted. The mounting grooves 22 are grooves open forward and long in the lateral direction (width direction) and open in three directions of a forward direction and leftward and rightward directions (width direction), and the strip-like coupling portions 43 of the busbar pieces 40 are mountable thereinto from front. The busbar pieces 40 are stopped at rear end positions by the rear end surfaces of the strip-like coupling portions 43 coming into contact with the back surfaces (rear surfaces) of the mounting grooves 22 as shown in FIG. 17 when being mounted. Further, the mounting grooves 22 are formed in two upper and lower levels in the busbar piece holding portion 21.

As shown in FIG. 7, the second connecting portion insertion hole 24 into which the second electronic component connecting portion 45B of the second busbar piece 40B is insertable is formed to penetrate through the back surface of the mounting groove 22 in the upper level. As shown in FIG. 17, the second electronic component connecting portion 45B is inserted into the mounting groove 22 from front and projects into the intermediate portion 31 through the second connecting portion insertion hole 24. Note that a width of the second connecting portion insertion hole 24 is substantially equal to that of the second electronic component connecting portion 45B.

As shown in FIG. 5, the busbar piece holding portion 21 is formed with an insertion hole 25 allowing the mounting grooves 22 in the upper and lower levels to communicate in the vertical direction. As shown in FIG. 1, the insertion hole 25 enables the insertion of the bent part of the first electronic component connecting portion 45A of the first busbar piece 40A, and a width thereof is slightly larger than that of the bent part of the first electronic component connecting portion 45A. Further, as shown in FIG. 7, a first connecting portion insertion hole 23 into which the welding portion 48A of the first electronic component connecting portion 45A is insertable is formed to penetrate through the back surface of the mounting groove 22 in the upper level. As shown in FIGS. 17 and 18, the welding portion 48A of the first electronic component connecting portion 45A is inserted into the mounting groove 22 in the upper level from front and projects into the intermediate portion 31 through the first connecting portion insertion hole 23. At that time, the bent part is inserted into the insertion hole 25. Note that a width of the first connecting portion insertion hole 23 is larger than that of the insertion hole 25 and enables the insertion of the welding portion 48A of the first electronic component connecting portion 45A.

Further, as shown in FIG. 5, the holder press-fit hole 26 is formed at a position corresponding to the first press-fit portion 51 of the first busbar piece 40A on the back surface of the mounting groove 22 in the lower level. The holder press-fit hole 26 is formed in a substantially widthwise (lateral) center of the busbar piece holding portion 21 and penetrates to a rear side of the busbar piece holding portion 21.

As shown in FIGS. 6 and 7, the intermediate portion 31 includes a pair of side wall portions 32 provided to face each other in the width direction, an intermediate coupling portion 33 coupling these side wall portions 32 and a lead wire supporting portion 34 for supporting the lead wires 62 from below. The pair of side wall portions 32 face each other substantially in parallel and the front ends thereof are coupled to the busbar piece holding portion 21. The intermediate coupling portion 33 is provided to couple rear end parts of the side wall portions 32 and also coupled to the capacitor holding portion 35 by being integrally formed to a lower part of a spacer 38 to be described later. Further, the lead wire supporting portion 34 for supporting the lead wires 62 of the capacitor 60 is provided on the front end of the intermediate coupling portion 33. The lead wire supporting portion 34 is cantilevered forward from the intermediate coupling portion 33 and resiliently deformable in the vertical direction. In the intermediate portion 31, a space enclosed by the pair of side wall portions 32, the busbar piece holding portion 21 and the capacitor holding portion 35 is open in the vertical direction so that the capacitor holding portion 35 and electrodes (not shown) for resistance-welding the lead wires 62 can be arranged.

As shown in FIGS. 6 and 7, the capacitor holding portion 35 includes a substantially hollow cylindrical tubular portion 36 for accommodating the capacitor main body 61 inside, rotation restricting grooves 37 for guiding the lead wire projecting portions 64 of the lead wires 62 and the spacer 38 to be arranged between the lead wires 62 of the capacitor 60. The tubular portion 36 is so formed that an axial direction is aligned with the front-back direction, and a rear end side thereof is entirely open to serve as a capacitor insertion opening 39 into which the capacitor 60 is insertable and the capacitor 60 can be accommodated thereinto from behind. Further, a front end side of the tubular portion 36 is also open to enable the insertion of the lead wires 62. As shown in FIG. 8, the tubular portion 36 has such a length as to cover about the front two-thirds of the capacitor main body 61. That is, the capacitor main body 61 includes a part not covered by the tubular portion 36. Further, a part of an upper surface part of the tubular portion 36 extends forward, and the column-like spacer 38 coupled to the intermediate coupling portion 33 is provided to project downward from this extending part. The spacer 38 prevents the contact of the lead wires 62 with each other and prevents a forward movement of the capacitor main body 61 from a specified position.

On the other hand, as shown in FIGS. 7 and 8, the rotation restricting grooves 37 are continuous with partial cut parts on opposite left and right sides of a substantially central part of the tubular portion 36 in the height direction, communicate with a space formed by the tubular portion 36 for accommodating the capacitor main body 61 and are located radially outward of the tubular portion 36 (radially outward of the accommodated capacitor main body 61). The lower ends of the rotation restricting grooves 37 are substantially at the same height position as the upper surface of the lead wire supporting portion 34. Further, the rotation restricting grooves 37 are formed over the entire length of the tubular portion 36 in the front-back direction (depth direction), and a distance W1 between inner sides of the rotation restricting grooves 37 is slightly larger than a distance between outer sides of the lead wire projecting portions 64. Note that the rear end parts of the rotation restricting grooves 37 and the tubular portions 36 are widened radially outwardly to facilitate the insertion of the capacitor 60.

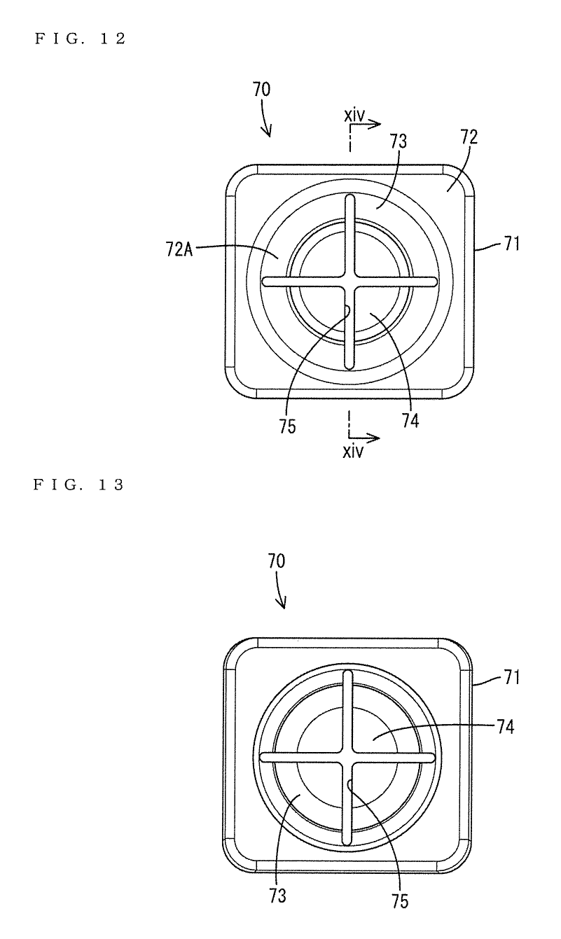

Next, the retainer 70 is described. As shown in FIG. 12, the retainer 70 is a component made of resin and in the form of a shallow box having a substantially rectangular plan view and an open rear part. The retainer 70 is composed of an outer wall portion 71 surrounding four sides as a whole, a front end surface 72 covering a front side of the outer wall portion 71, an inner wall side portion 73 provided substantially in a central part of the front end surface 72, formed to be recessed backward, divided into four by a slit 75 and having a hollow cylindrical shape as a whole, and a round bottom surface 74 provided on the rear end of the inner wall side portion 73, divided into four by the slit 75 and having a substantially circular shape as a whole, and the rear end surface of the outer wall portion 71 is open. As shown in FIG. 17, the outer peripheral shape of the retainer 70 is substantially the same as the inner peripheral shape of the capacitor accommodating portion 18 of the housing main body 10, a length of the retainer 70 in the front-back direction is substantially equal to a length from the rear end of the capacitor holding portion 35 to the inner back end surface of the capacitor accommodating portion 18, and the retainer 70 is accommodated without looseness in the capacitor accommodating portion 18.

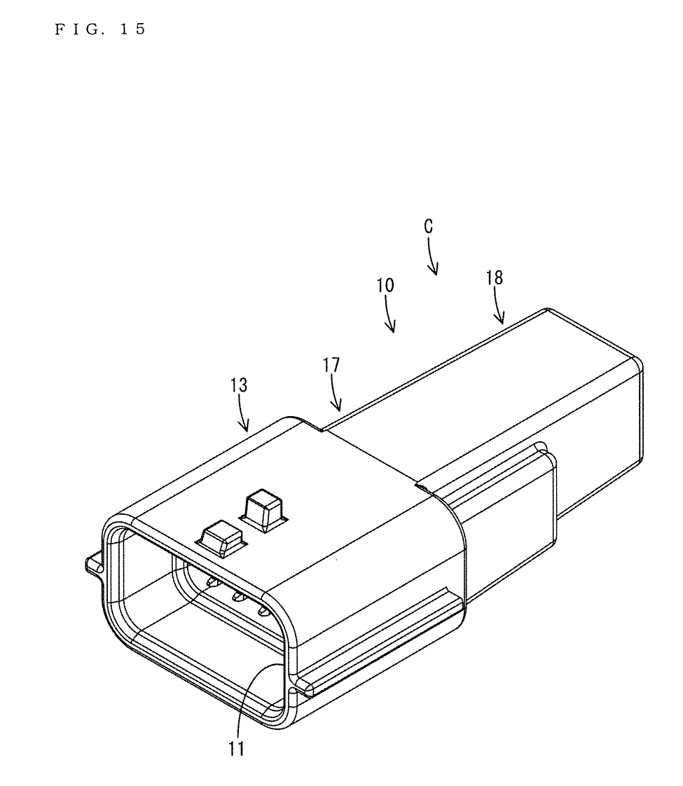

As shown in FIG. 14, a hollow space is defined between the outer wall portion 71 and the inner wall side portion 73 of the retainer 70 and the inner wall side portion 73 is deformable toward the outer wall portion 71. A front end part of the inner wall side portion 73 is connected to the outer wall portion 71 and the front end surface 72 and dimensioned to be slightly larger than maximum dimensions of the capacitor main body 61 within dimensional tolerances. A tapered portion 73A whose diameter is gradually reduced from the front end part of the inner wall side portion 73 toward a rear side is provided, and a constant diameter portion 73B having a constant diameter is provided to extend to the rear end from a position where the tapered portion 73A has a slightly smaller diameter than a minimum diameter of the capacitor main body 61 within the dimensional tolerances. The slit 75 is formed to extend from the tapered portion 73A of the inner wall side portion 73 toward the round bottom surface 74. The slit 75 has a cross shape centered on a center of the round bottom surface 74 and penetrates through the inner wall side portion 73 and the round bottom surface 74 in a thickness direction. When the capacitor main body 61 is inserted, the slit 75 is widened, wherefore the capacitor main body 61 can be accommodated even if an outer diameter of the capacitor main body 61 is larger than an inner diameter of the inner wall side portion 73.

Next, the structure of the housing main body 10 is described.

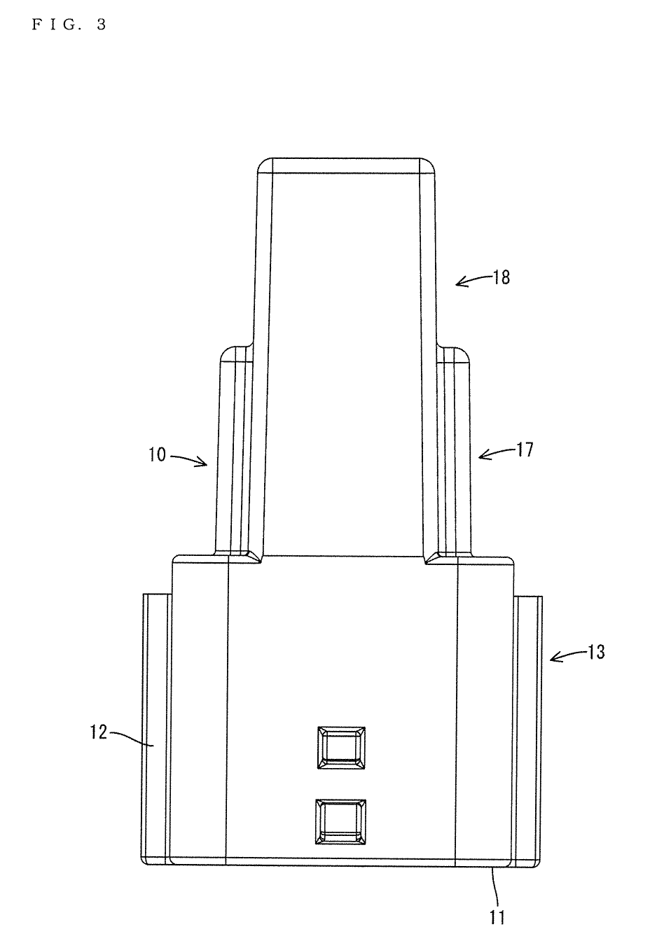

As shown in FIGS. 2 and 3, a connection bottom surface 14 of the receptacle 13 is recessed backward to form the capacitor accommodating portion 18. Further, the connection bottom surface 14 is recessed to have a larger opening than the capacitor accommodating portion 18, thereby forming the holder accommodating portion 17. Pairs of housing insertion grooves 15 into which opposite end parts of the strip-like coupling portions 43 (see FIG. 17) of the busbar pieces 40 are to be inserted are formed at opposite left and right sides of the holder accommodating portion 17 in a coupling part of the receptacle 13 and the holder accommodating portion 17. Further, the rear surfaces of the housing insertion grooves 15 are recessed to form the housing press-fit holes 16 extending backward, and the housing press-fit portions 55 can be press-fit into the housing press-fit holes 16.

The holder accommodating portion 17 can accommodate the intermediate portion 31 (see FIG. 6) of the holder 20 and is sized to be able to accommodate the intermediate portion 31 of the holder 20 without looseness.

As shown in FIG. 17, the capacitor accommodating portion 18 can accommodate the capacitor holding portion 35 of the holder 20. The capacitor accommodating portion 18 has a length sufficient to provide a space behind the capacitor accommodating portion 18 even if the capacitor holding portion 35 is accommodated at a predetermined position. This space is filled up by a rear end part of the retainer 70.

This embodiment is configured as described above. Next, how to assemble this embodiment is described using FIGS. 1 and 17.

First, the first busbar piece 40A is mounted into the holder 20. The first busbar piece 40A is pushed backward with the first electronic component connecting portion 45A in the lead such that the strip-like coupling portion 43A is located in the mounting groove 22 in the lower level, the bent part of the first electronic component connecting portion 45A is located in the insertion hole 25 and the wide part of the first electronic component connecting portion 45A is located in the mounting groove 22 in the upper level (front side of the first connecting portion insertion hole 23). Then, the first press-fit portion 51 is press-fit into the holder press-fit hole 26 (see FIG. 5) of the mounting groove 22 in the lower level and the welding portion 48A of the first electronic component connecting portion 45A projects into a hollow part of the intermediate portion 31. When the rear end surface of the strip-like coupling portion 43A comes into contact with the back surface of the mounting groove 22 in the lower level, the pushing of the first busbar piece 40A is stopped. Note that the first electronic component connecting portion 45A is not press-fit when being inserted into the insertion hole 25 and the first connecting portion insertion hole 23, and only the first press-fit portion 51 is press-fit. In this way, the first busbar piece 40A is held in the busbar piece holding portion 21 by the first press-fit portion 51 biting into the inner peripheral surface of the holder press-fit hole 26.

Subsequently, the second busbar piece 40B is mounted into the holder 20. The second busbar piece 40B is pushed backward with the second electronic component connecting portion 45B in the lead such that the second strip-like coupling portion 43B is located in the mounting groove 22 in the upper level and the second electronic component connecting portion 45B is located in a front side of the second connecting portion insertion hole 24. Then, the second press-fit portions 53 of the second electronic component connecting portion 45B are press-fit into the second connecting portion insertion hole 24 and a tip part of the second electronic component connecting portion 45B projects into the hollow part of the intermediate portion 31. When the rear end surface of the second strip-like coupling portion 43B comes into contact with the back surface of the mounting groove 22 in the upper level, the pushing of the second busbar piece 40B is stopped. In this way, the second busbar piece 40B is held in the busbar piece holding portion 21 by the second press-fit portions 53 biting into inner surfaces of the second connecting portion insertion hole 24.

When the busbar pieces 40 are mounted into the holder 20 as just described, the housing press-fit portions 55 and the opposite left and right end parts of the strip-like coupling portions 43 project to the both left and right sides from the busbar piece holding portion 21.

The capacitor 60 is mounted into the capacitor holding portion 35 after the busbar pieces 40 are mounted. The capacitor 60 is inserted through the capacitor insertion opening 39 of the tubular portion 36 with the lead wires 62 facing forward and the lead wire projecting portions 64 of the respective left and right lead wires 62 are inserted into the respective left and right rotation restricting grooves 37. The lead wires 62 are guided and inserted while vertical (circumferential) movements of the lead wire projecting portions 64 are suppressed by the rotation restricting grooves 37. When the front end surface 61A of the capacitor main body 61 reaches a position where it comes into contact with the rear end of the spacer 38, the insertion of the capacitor 60 is stopped. In this state, the rear end part (about one-third of the entire length) of the capacitor main body 61 is projecting from the tubular portion 36. When the capacitor 60 is longitudinally mounted at a predetermined position, the lead wires 62 and the welding portions 48A, 48B are resistance-welded while being sandwiched by a pair of upper and lower electrodes for resistance welding.

When the lead wires 62 of the capacitor 60 are resistance-welded, the retainer 70 is mounted on a rear end part of the capacitor main body 61 from behind. When the tapered portion 73A (see FIG. 14) of the retainer 70 comes into contact with the rear end part of the capacitor main body 61, the rear end part of the capacitor main body 61 is inserted toward a back side of the retainer 70 by being guided by the tapered portion 73A. That is, the retainer 70 is pushed toward a front side of the capacitor main body 61. At this time, the slit 75 is gradually opened, whereby the inner wall side portion 73 of the retainer 70 is deformed according to the size of the capacitor main body 61 and clamps and holds the capacitor main body 61. The pushing of the retainer 70 is stopped by the contact of the front end of the outer wall portion 71 and the front end surface 72 with the rear end of the capacitor holding portion 35 of the holder 20.

Subsequently, the holder 20 mounted with the busbar pieces 40 and the capacitor 60 is mounted into the housing main body 10. The holder 20 is inserted through the insertion opening 11 with the capacitor 60 mounted with the retainer 70 in the lead. The busbar pieces 40 are pushed into by pressing end parts of the busbar pieces 40 (strip-like coupling portions 43) projecting from the holder 20. The housing press-fit portions 55 of the busbar pieces 40 are press-fit into the housing press-fit holes 16. The rear end surfaces of the end parts of the strip-like coupling portions 43 projecting from the holder 20 come into contact with the rear surfaces of the housing insertion grooves 15, whereby the pushing is stopped. When the pushing of the busbar pieces 40 is stopped, the holder 20 is also arranged at a predetermined position in the housing main body 10 together with the busbar pieces 40. At this time, the rear end of the outer wall portion 71 of the retainer 70 comes into contact with the inner bottom surface of the capacitor accommodating portion 18 and the retainer 70 is accommodated without looseness. In this way, the retainer 70 fills up a clearance formed between the capacitor main body 61 and the inner surface of the capacitor accommodating portion 18, thereby suppressing the vibration of the capacitor main body 61 due to vibration from outside. Further, the busbar pieces 40 are held in the housing main body 10 by the housing press-fit portions 55 biting into the inner peripheral surfaces of the housing press-fit holes 16.

As described above, the longitudinal arrangement in which the capacitor main body 61 is arranged in the front-back direction is adopted and the retainer 70 holds the capacitor main body 61 so as not to form any clearance between the housing main body 10 and the capacitor main body 61 even if the pair of lead wires 62 are respectively drawn out in the same direction from one end (front end surface 61A) of the capacitor main body 61 in the capacitor 60. Further, the retainer 70 is deformable so as to absorb dimensional tolerances of the capacitor main body 61. Thus, the retainer 70 fills up the clearance between the capacitor main body 61 and the housing main body 10 (capacitor accommodating portion 18) while absorbing the dimensional tolerances of the capacitor main body 61, wherefore the vibration of the capacitor 60 can be suppressed and the breakage of welded parts of the lead wires 62 and the welding portions 48A, 48B of the busbar pieces 40 can be avoided.

Further, the connector C1 is formed of the holder 20 for holding the busbar pieces 40 and the housing main body 10 including the insertion opening 11 into which the holder 20 is insertable from front and capable of accommodating the holder 20 inside, and the retainer 70 is mounted on the rear end part of the capacitor main body 61 while the front end part of the capacitor main body 61 is held in the holder 20 (capacitor holding portion 35). In such a configuration, the busbar pieces 40 and the lead wires 62 of the capacitor 60 can be connected after the busbar pieces 40 and the capacitor 60 are held in the holder 20. Thus, operability is improved. Further, since the holder 20 holding the busbar pieces 40 and the capacitor 60 can be accommodated into the housing main body 10 after the retainer 70 is mounted on the capacitor 60, operability is improved.

Further, in this embodiment, the capacitor main body 61 is formed into a substantially solid cylindrical shape and the retainer 70 is such that the inner wall side portion 73 is formed into a substantially hollow cylindrical shape as a whole, the round bottom surface 74 has a substantially circular shape and the slit 75 is formed from the inner wall side portion 73 toward the center of the round bottom surface 74. In such a configuration, the slit 75 provided in the retainer 70 is opened according to the size of the capacitor main body 61, thereby being able to deal with a size change due to the dimensional tolerances of the capacitor main body 61.

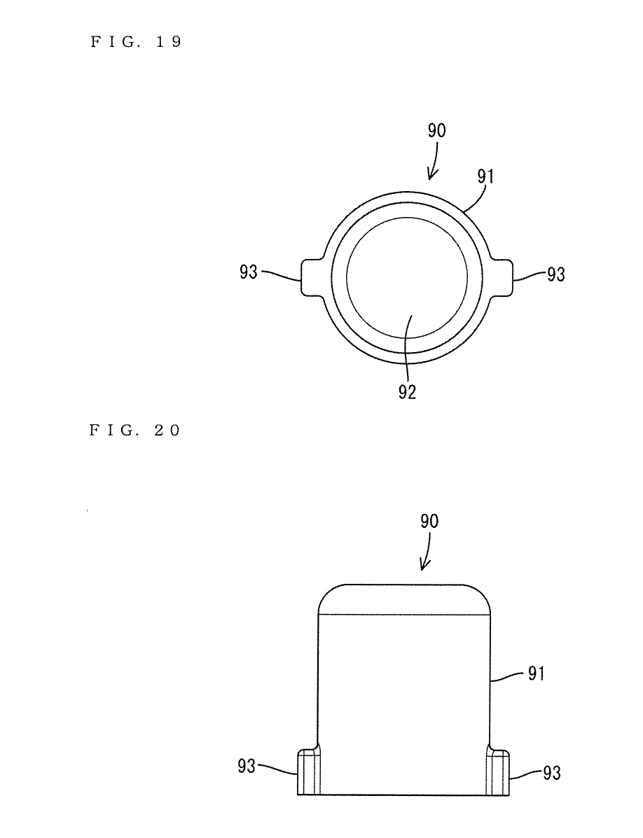

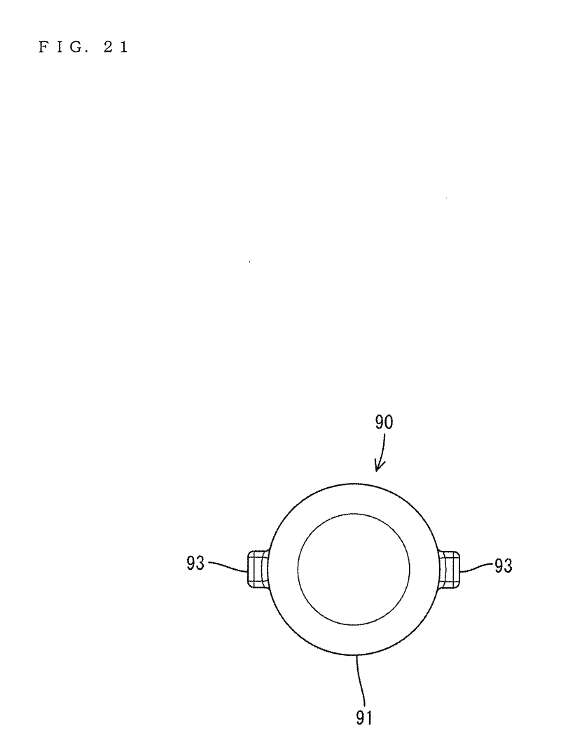

Next, a second embodiment of the present invention is described with reference to FIGS. 19 to 22. A connector with an electronic component (hereinafter, merely referred to as a connector C10) in this embodiment differs from the connector C1 of the first embodiment in the configuration of a holding component and the shape of the housing main body 10 (capacitor accommodating portion 18). Other common configurations, functions and effects are not described since being the same as in the first embodiment. Further, the same components as in the first embodiment are denoted by the same reference signs. Further, components corresponding to the first embodiment are denoted by reference signs obtained by adding 100 to numerical parts of the reference signs of the first embodiment.

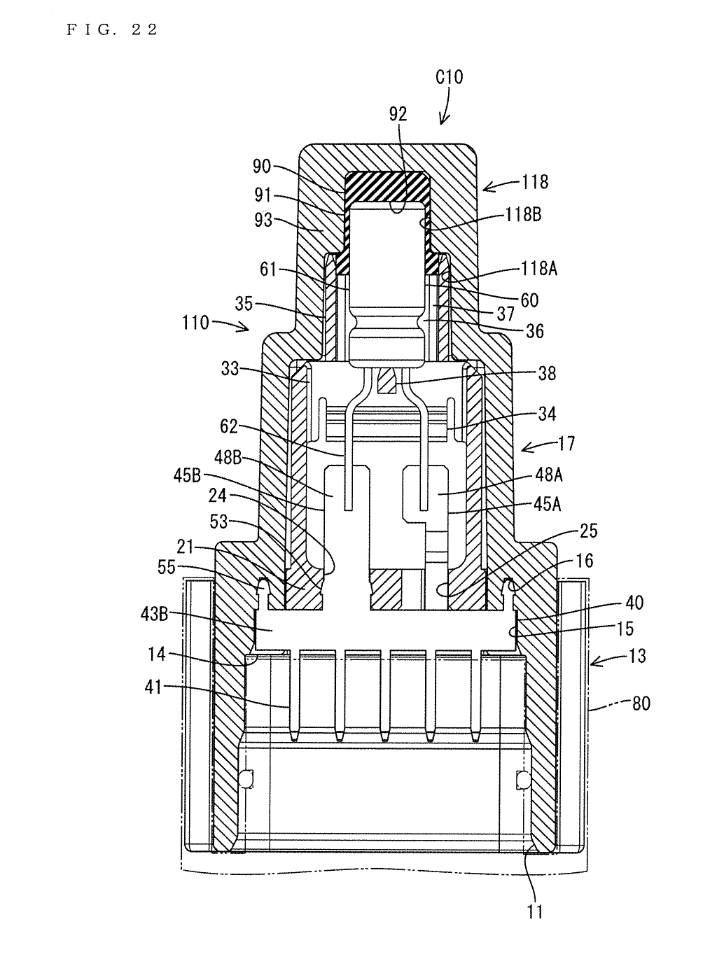

In this embodiment, the inner surface of a capacitor accommodating portion 118 of a housing main body 110 is so formed as to define two differently dimensioned spaces, i.e. a wide portion 118A capable of accommodating a capacitor holding portion 35 of a holder 20 and a narrow portion 118B capable of accommodating a rear end part of a capacitor main body 61 and a cap 90 to be described later as shown in FIG. 22. A length of the wide portion 118A in the front-back direction is substantially equal to that of the capacitor holding portion 35. On the other hand, the remaining part is the narrow portion 118B, the inner peripheral surface of which is formed into a substantially hollow cylindrical shape and has an inner diameter larger than an outer diameter of the capacitor main body 61.

As shown in FIGS. 19 to 21, the cap 90 of this embodiment is formed of vibration absorbing rubber and composed of a cylinder portion 91 having a substantially hollow cylindrical shape and capable of accommodating the capacitor main body 61, a cylinder bottom surface 92 formed on the rear end of the cylinder portion 91 and projecting portions 93 formed on a front end part of the cylinder portion 91. The cylinder portion 91 has such a thickness as to fill up a clearance formed between the capacitor accommodating portion 118 and the capacitor main body 61 when the capacitor main body 61 is accommodated into the housing main body 110, an outer diameter thereof is substantially equal to an inner diameter of the narrow portion 118B of the capacitor accommodating portion 118 and an inner diameter thereof is substantially equal to a minimum outer diameter of the capacitor main body 61 within the range of dimensional tolerances. The cylinder bottom surface 92 has a thickness equal to a maximum value of the clearance between the capacitor main body 61 and the capacitor accommodating portion 118. The projecting portions 93 are formed to project radially outward on the front end part of the cylinder portion 91, and a distance between outer projecting ends thereof is substantially equal to a distance W1 between inner sides of rotation restricting grooves 37.

Next, how to assemble the connector C10 of this embodiment is described. A process until busbar pieces 40 and a capacitor 60 are mounted into the holder 20 and lead wires 62 and welding portions 48A, 48B are resistance-welded is not described since being the same as in the first embodiment.

When the lead wires 62 of the capacitor 60 are resistance-welded, the cap 90 is mounted from behind the capacitor main body 61. Since the cap 90 is formed to have the minimum inner diameter of the capacitor main body 61 within the tolerances, the capacitor main body 61 is press-fit in most cases. When the capacitor main body 61 is press-fit into the cap 90, the cap 90 is mounted by being pushed forward of the capacitor main body 61. When the projecting portions 93 are inserted into the rotation restricting grooves 37 to be accommodated therein, the rear end of the capacitor main body 61 comes into contact with the inner surface of the cylinder bottom surface 92 and the cap 90 is mounted on the capacitor main body 61.

Subsequently, the holder 20 mounted with the busbar pieces 40 and the capacitor 60 is mounted into the housing main body 110. The holder 20 is inserted through the insertion opening 11 with the capacitor 60 mounted with the cap 90 in the lead. The busbar pieces 40 are pushed into by pressing end parts of the busbar pieces 40 (strip-like coupling portions 43) projecting from the holder 20. Housing press-fit portions 55 of the busbar pieces 40 are press-fit into housing press-fit holes 16. The rear end surfaces of end parts of the strip-like coupling portions 43 projecting from the holder 20 come into contact with the rear surfaces of housing insertion grooves 15, whereby the pushing is stopped. When the pushing of the busbar pieces 40 is stopped, the holder 20 is also arranged at a predetermined position in the housing main body 10 together with the busbar pieces 40. At this time, the cap 90 is pushed to be accommodated into the narrow portion 118A of the capacitor accommodating portion 118 while being resiliently deformed by the inner surface of the capacitor accommodating portion 118. In this way, the cap 90 fills up the clearance formed between the capacitor main body 61 and the inner surface of the capacitor accommodating portion 118, thereby suppressing the vibration of the capacitor main body 61 due to vibration from outside. Further, the busbar pieces 40 are held in the housing main body 10 by the housing press-fit portions 55 biting into the inner peripheral surfaces of the housing press-fit holes 16.

In this embodiment, the capacitor main body 61 is formed into a substantially solid cylindrical shape, the cap 90 is formed of a resilient member (vibration absorbing rubber) and includes the cylinder portion 91 formed into a substantially hollow cylindrical shape and configured to cover the capacitor main body 61 and fill up the clearance to the housing main body 110 (capacitor accommodating portion 118) and the projecting portions 93 projecting radially outward from the cylinder portion 91, and the holder 20 is formed with the rotation restricting grooves 37 capable of accommodating the projecting portions 93. In such a configuration, when the substantially hollow cylindrical cylinder portion 91 is mounted on the solid cylindrical capacitor main body 61, the cylinder portion 91 can be deformed due to the dimensional tolerances of the capacitor main body 61 and fill up the clearance between the housing main body 110 (capacitor accommodating portion 118) and the capacitor main body 61 to alleviate vibration since the cylinder portion is a resilient component. Further, the projecting portions 93 improve mountability into the holder 20 and prevent the rotation of the cap 90 and the capacitor main body 61 mounted with the cap 90.

The present invention is not limited to the above described and illustrated embodiments. For example, the following embodiments are also included in the technical scope of the present invention.

Although the electronic component is the capacitor 60 in the above embodiments, there is no limitation to this and the electronic component may be any one of various electronic components such as resistors, diodes and transistors as long as it is shaped to be long in the front-back direction and the lead wires project from one end surface.

Although the capacitor main body 61 is formed into a substantially solid cylindrical shape in the above embodiments, it may be formed into a substantially rectangular column shape. Further, another shape may be adopted if the inner peripheral shape of the retainer or the cap can be changed in conformity with that shape.

Although the lead wires 62 of the capacitor 60 are in the form of round pins in the above embodiments, there is no limitation to this and the lead wires of the capacitor may be, for example, in the form of rectangular columns.

Although the busbar pieces 40 are held in the holder 20 in the above embodiments, they may be connected to the electronic component in a state not held in the holder 20. Further, although the capacitor 60 is also held in the holder 20, it may be connected to a conductive member in a state not held in the holder 20. For example, the conductive member and the electronic component may be accommodated and held in the housing after being connected to each other.

Although the housing main body 10 and the holder 20 are used in the above embodiments, a connector may be configured such that a holder and a housing are integral.

Although the retainer 70 or the cap 90 are inserted into the housing main body 10 after being mounted on the capacitor main body 61 in the above embodiments, the electronic component may be inserted after the retainer 70 or the cap 90 are inserted and fixed in the housing.

Although the inner wall side portion 73 of the retainer 70 includes the tapered portion 73A and the constant diameter portion 73B in the first embodiment, the entire retainer 70 may be tapered or have a constant diameter up to the round bottom surface 74.

Although the slit 75 has a cross shape in the first embodiment, the shape thereof is not limited to the cross shape. For example, the number of slits may be five or six if the slits radially extend from the center of the round bottom surface. The slits radially extending in this way are preferable for equal spreading. However, the shape of the slit(s) may have another shape other than the radial shape if it can be changed according to the size of the electronic component.

Although the projecting portions 93 are fitted into the rotation restricting grooves 37 in the second embodiment, recesses may be formed on the capacitor accommodating portion (housing) and the projecting portions may be fitted thereinto. In such a case, the formation positions of the projecting portions are not limited to those at the front end of the cylinder portion and the projecting portions may be formed at other positions.

Although the capacitor accommodating portion 118 includes the narrow portion 118B in the second embodiment, the narrow portion 118B may have the same width as the wide portion 118A. In such a case, the thickness of the cap is increased to fill up a clearance to the housing.

Although the cap 90 is formed of the rubber material in the second embodiment, it may be formed of any resilient material capable of suppressing vibration other than rubber.

What is claimed is:

1. A connector, comprising:
an electronic component (60) with an electronic component main body (61) extending in a front-back direction and a lead wire (62) projecting forward from a front end surface (61A) of the electronic component main body (61);
a conductive member (40) arranged before the electronic component (60) and connected to the lead wire (62);
a housing (10, 20) into which the electronic component (60) and the conductive member (40) are mountable; and
a holding component (70; 90) separate from the housing (10, 20) mounted between the housing (10, 20) and the electronic component main body (61), the holding component (70; 90) being deformable according to a size of a clearance between the electronic component main body (61) and the housing (10, 20).

2. The connector of claim 1, wherein:
the housing (10, 20) comprises a holder (20) for holding the conductive member (40) and a housing main body (10) including an insertion opening (11) through which the holder is insertable and capable of accommodating the holder (20) inside through the insertion opening (11); and
the holding component (70; 90) is mounted on a rear end part of the electronic component main body (61) while a front end part of the electronic component main body (61) is held in the holder (20).

3. The connector of claim 2, wherein:
the electronic component main body (61) has a substantially solid cylindrical shape; and
the holding component (70) has an inner peripheral side surface (73) defining a substantially hollow cylindrical shape, an inner peripheral bottom surface (74) defining a substantially circular shape and a slit (75) being formed from the inner peripheral side surface (73) toward a center of the inner peripheral bottom surface (74).

4. The connector of claim 2, wherein:
the electronic component main body (61) has a substantially solid cylindrical shape
the holding component (90) is a resilient member and includes a cylinder portion (91) having a substantially hollow cylindrical shape and configured to cover the electronic component main body (61) and fill up a clearance to the housing (10) and a projecting portion (93) projecting radially out from the cylinder portion (91); and
the housing (10) is formed with a recess (37) capable of accommodating the projecting portion (93).
